(19) United States
(12) Patent Application Publication
(10) Pub. No.: US 2026/0086604 A1
(43) Pub. Date: Mar. 26, 2026

(54) FLEXIBLE FACIAL INTERFACE

(71) Applicant: Meta Platforms Technologies, LLC, Menlo Park, CA (US)

(72) Inventors: Meng Peng, Sammamish, WA (US); Richard Andrew Sorensen, Camas, WA (US); Simon Morris Shand Weiss, Seattle, WA (US); Anthony Torris, Mercer Island, WA (US); Benjamin Peterson, Seattle, WA (US); Jessie Cindy Maikim, San Francisco, CA (US); David Michael Pickett, Seattle, WA (US); Quintin Morris, Tacoma, WA (US)

(21) Appl. No.: 19/337,681

(22) Filed: Sep. 23, 2025

Related U.S. Application Data
(60) Provisional application No. 63/698,469, filed on Sep. 24, 2024.

(51) Int. Cl. G06F 1/16

(52) U.S. Cl. CPC G06F 1/163

(57) ABSTRACT

The disclosure comprises an apparatus configured to engage a mixed reality head mounted device (HMD). The apparatus can include a chassis configured to engage a surface on an HMD and a facial ribbon coupled to the fabric trim frame. A coupling can be configured to engage the chassis frame and the facial ribbon; the facial ribbon comprises at least one pivoting hinge-type structure. The apparatus can comprise an occlusion wrap. The apparatus can further comprise a face pad wherein the face pad is configured to mate with a contour profile of the facial ribbon determined by the shape of the facial ribbon.

### CROSS REFERENCE TO RELATED APPLICATIONS

This present application claims the benefit of priority under 35 U.S.C. § 119(e) to U.S. Provisional Application No. 63/698,469, filed Sep. 24, 2024, the disclosure of which is hereby incorporated by reference in its entirety for all purposes.

This application is related to U.S. patent application Ser. No. __/______ filed Sep. 23, 2025, which claims the benefit of U.S. Provisional Application No. 63/698,462, filed Sep. 24, 2024, each of which is owned by Applicant and is incorporated herein by reference and which is not admitted to be prior art with respect to the present invention by its mention in the cross-reference section.

### TECHNICAL FIELD

The present disclosure generally relates to user comfort in a headset device, and more particularly to customizing wearability for a plurality of users.

### BACKGROUND

Head mountable devices include the visual displays in mixed reality (MR) environments. Heat dissipation in virtual reality (VR) headsets is critical for both user comfort and hardware performance. As VR headsets become more powerful, especially standalone models, managing heat becomes increasingly challenging. Head mounted devices (HMD) can be cumbersome on a user's head. To provide support and engagement to a wearer's face, the HMD can include a head strap that can circumscribe the wearer's head. However, an issue with an HMD and a head strap is the lack of user comfort that can be exacerbated with continued use. Further, the combination of the HMD and head strap can require additional structures to increase user comfort. In another aspect, enhancing user comfort can require a customized solution and a plurality of parts to append to the HMD.

### BRIEF SUMMARY

The subject disclosure provides for an apparatus configured to engage a mixed reality head mounted device (HMD). In an embodiment, an apparatus can be configured to engage a mixed reality head mounted device (HMD). The apparatus can comprise a chassis configured to engage a surface on an HMD; a fabric trim frame coupled to the chassis; and a facial ribbon coupled to the fabric trim frame. The engagement between the chassis frame and fabric trim frame can comprise a coupling comprising at least one pivoting hinge-type structure. The apparatus can include an occlusion wrap oriented to engage between the fabric trim frame and the facial ribbon. The facial ribbon comprises a ribbon protrusion oriented at a top surface of the fabric trim frame. The ribbon protrusion can be oriented to linearly translate into a top region engagement with the fabric trim frame. The top region engagement with the fabric trim frame can include a spring. The spring can be structured to receive a force from the ribbon protrusion extending from the facial ribbon while the facial ribbon is coupled to the fabric trim frame. The spring can be a torsion spring. The apparatus can further comprise a face pad wherein the face pad is configured to mate with a contour profile of the facial ribbon determined by the shape of the facial ribbon. The face pad comprises a plurality of elastic materials. The plurality of elastic materials is distributed in the face pad to compensate for a plurality of pressure points applied to the face pad, such that the pressure points are generated by a user's face. The apparatus can include at least one pivoting hinge-type structure comprising a vertical alignment and the at least one pivoting hinge-type structure located on a side surface of the facial ribbon. The pivoting hinge-type structure can comprise an over rotation flange. In a further aspect, the contour of the facial ribbon is shaped to mirror a face. The apparatus can further comprise an occlusion wrap comprising a fabric material, wherein the fabric material is preloaded. The fabric material is preloaded at a plurality of engagement points located at an initial coupling with the fabric trim frame and a supplemental coupling with the facial ribbon. In a further aspect, the occlusion wrap comprises a textured surface, wherein a component of the texture extends above the textured surface. In the apparatus at least one of: the chassis, the fabric trim frame, and the facial ribbon comprises an oil-resistant additive to prevent decomposition.

In a second embodiment of the disclosure, an apparatus configured to engage a mixed reality head mounted device (HMD) can include: a chassis frame configured to engage a rear surface of the HMD; and a facial ribbon comprising a contour profile. The facial ribbon is coupled to a rear surface of the chassis frame, wherein the facial ribbon comprises at least one pivoting hinge-type structure. The apparatus can further comprise a face pad wherein the face pad is breathable and configured to mate with a contour profile of the facial ribbon determined by the shape of the facial ribbon. The face pad comprises a plurality of elastic materials; the plurality of elastic materials is distributed in the face pad to compensate for a plurality of pressure points applied to the face pad such that the pressure points are generated by a user's face. With the apparatus, the facial ribbon comprises a ribbon protrusion configured to translate linearly towards an engagement with the chassis frame. The ribbon protrusion translates in a channel defined by a top region of the chassis frame. The at least one pivoting hinge-type structure comprises a vertical alignment, and the at least one pivoting hinge-type structure is located on a side surface of the facial ribbon. The chassis frame comprises lobe protrusions configured to extend forward from a top region of the chassis frame. The apparatus can further comprise an occlusion wrap comprising at least one of: a breathable material, a textured surface fabric material, or a matrix of interconnected members.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates the facial engagement assembly, in accordance with aspects of the disclosure.

FIG. 2 illustrates a front perspective view of a chassis component of the facial engagement assembly depicted in FIG. 1, further depicting multiple zoom views of connectors.

FIG. 3 illustrates a front perspective view of a fabric trim frame component of the facial engagement assembly depicted in FIG. 1, further depicting multiple zoom views of connectors.

FIG. 4 illustrates a front perspective view of the engagement between the fabric trim frame and facial ribbon along with multiple zoom views of connectors between the fabric trim frame and facial ribbon.

FIG. 5 illustrates a side perspective view of an occlusion wrap along with multiple zoom views of materials comprising the occlusion wrap.

FIG. 6 illustrates a cross-sectional view of the engagement between the chassis, facial trim frame, fabric material and face pad.

FIG. 7 illustrates an alternative embodiment of the facial engagement assembly coupled to a head mounted device (HMD).

FIG. 8 illustrates a rear perspective view of the alternative embodiment of the facial engagement assembly, according to certain aspects of the disclosure.

FIG. 9 illustrates a front perspective view of the face pad, according to certain aspects of the disclosure.

FIG. 10 illustrates the alternative embodiment of the facial engagement assembly comprising a facial occlusion wrap with multiple rear perspective zoom views of the alternative facial engagement assembly.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The term “mixed reality” or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer).

Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user's visual input is controlled by a computing system. “Augmented reality” or “AR” as used herein refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real world. For example, an AR headset could be shaped as a pair of glasses with a pass-through display, which allows light from the real world to pass through a waveguide that simultaneously emits light from a projector in the AR headset, allowing the AR headset to present virtual objects intermixed with the real objects the user can see. The AR headset may be a block-light headset with video pass-through. “Mixed reality” or “MR,” as used herein, refers to any of VR, AR, XR, or any combination or hybrid thereof.

The mixed reality content may include video, audio, haptic feedback, or some combination thereof, and any of which may be presented in a single channel or in multiple channels (such as stereo video that produces a three-dimensional visual effect to the viewer). Additionally, mixed reality may also be associated with applications, products, accessories, services, or some combination thereof, that are used to, e.g., create content in a mixed reality and/or are otherwise used in (e.g., perform activities in) a mixed reality. The mixed reality system that provides the mixed reality content may be implemented on various platforms, including a head-mountable display (sometimes referred to as a head-mounted display (HMD) without intending to require that the HMD is currently being worn on a user's head) connected to a host computer system, a standalone HMD, a mobile device or computing system, or any other hardware platform capable of providing mixed reality content.

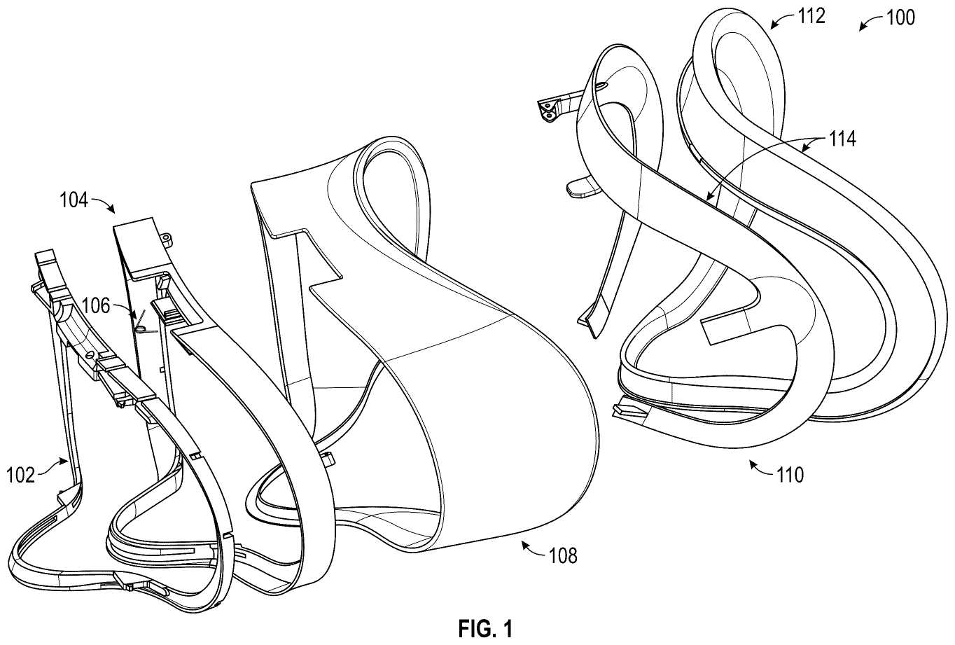

Current solutions do not effectively reduce heat generation when the HMD attempts to provide a more immersive experience by occluding more light while also being wearable by a plurality of different face shapes. The facial interface is configured to provide a plurality of facial shapes similar to sensations of comfort when using the HMD. As depicted in FIG. 1, the facial engagement assembly 100 can comprise a chassis 102 that is configured to interface with the head mounted device (HMD), not shown. The chassis 102 can further be coupled with the fabric trim frame 104. The facial engagement ribbon 110 can be coupled to the fabric trim frame 104. The chassis 102, fabric trim frame 104, and facial engagement ribbon 110 can comprise plastic-type materials, polymer, or carbon composite materials that permit flexibility. For example, PC-ABS (Polycarbonate/Acrylonitrile Butadiene Styrene) or TR-90 can be used as a material for these modular components of the facial engagement assembly; materials such as PC-ABS or TR-90 can provide durability, high strength, flexibility and heat resistance. The fabric trim frame can be configured to engage an occlusion wrap 108. The facial engagement ribbon 110 can also be configured to engage face pad 112. The face pad 112 can comprise a resilient material that deforms upon compression and reforms to an undeformed state when the force is removed. In a further aspect, the face pad 112 can comprise a breathable mesh covering. In a further aspect, the face pad can comprise a covering that is moisture wicking such that perspiration generated between the user's skin and the face pad can be dissipated and/or passively move away from the engagement between the user's skin for evaporation.

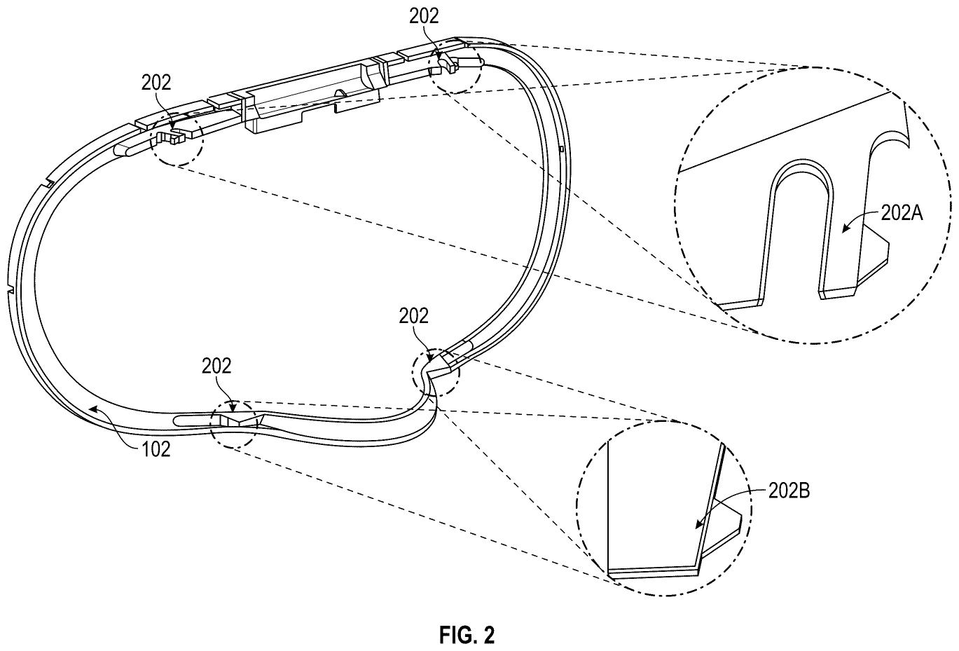

As mentioned earlier, the facial engagement assembly 100 comprises a modular construction of multiple components to allow a plurality of users to comfortably enjoy their experience in wearing the HMD. Referring back to the chassis 102, the chassis can comprise a frame configured to circumscribe the ocular and nasal region of a user's face when coupled to the HMD. In a further aspect, the ocular region can extend to the top half of the user's face, extending from the top of the forehead to the bridge of the nose and upper cheek area. Coverage of the top region of the face allows the user to have a cooling region on a lower end of the face. In a further aspect, the polycarbonate materials of the chassis 102, fabric trim frame 104, and facial ribbon 110 can be infused and/or coated with an additive to mitigate the corrosive effects of facial oils and lotions when the user's head or hands comes in contact with the components of the facial engagement assembly 100. As depicted in FIG. 2, the chassis can be configured with engagement connectors 202 that are structured to couple the facial engagement assembly 100 to the HMD. In one aspect, the engagement connectors 202 can comprise protrusions. When the facial engagement assembly 100 is coupled to the HMD, the engagement connectors 202 on the chassis can be configured to deflect and lock into a receiving crevice (not shown) on an HMD. In a further aspect, the engagement connectors can comprise a deflectable member 202A, which can be oriented at a top section of the chassis 102. The deflectable structure 202A can have a cantilevered shape that permits a deflection when a force is applied at the end of the beam. This force can be a translated force applied at the end of the deflectable member 202A when the HMD and chassis are coupled together. Another set of engagement connectors 202 can be an alignment member 202B, wherein the alignment member is structured to couple to a receive crevice defined by the body of the HMD. The alignment member 202B may not be structured to deflect during coupling to the HMD like the deflectable member 202A, but instead help ensure the chassis is properly aligned during coupling with the HMD and support the physical mass of the facial engagement assembly 100 while the facial engagement assembly is coupled to the HMD. In yet a further aspect, the engagement connectors 202 can be oriented on the perimeter of the chassis such that the weight of the facial engagement assembly 100 is evenly distributed and supported by the engagement connectors 202.

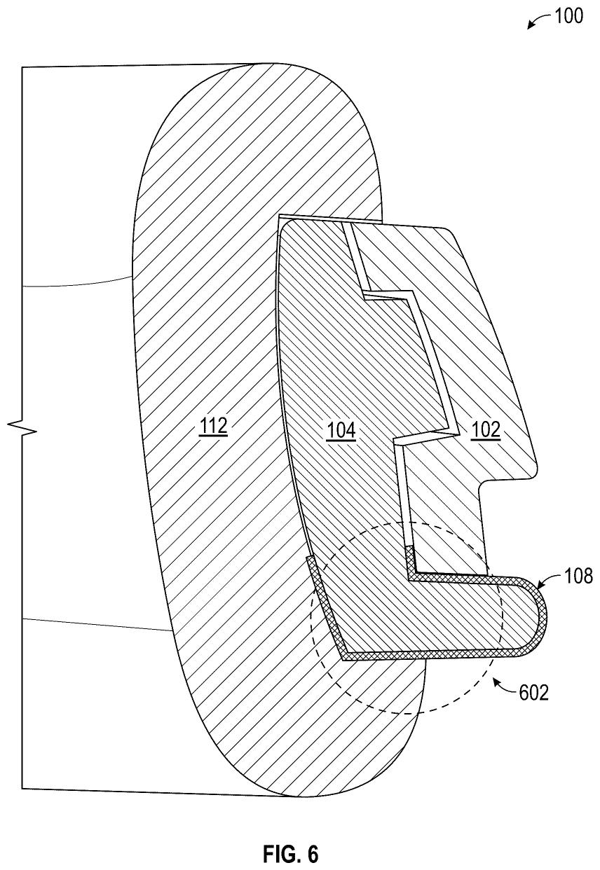

In a further aspect, the chassis 102 can be engaged to the fabric trim frame 104. As depicted in FIG. 1, the contoured shape of the chassis 102 can be configured to mate with the fabric trim frame 104. The fabric trim frame 104 can comprise a semi-rigid material such as a plastic-type material or carbon composite material that permits flexibility. As depicted in FIG. 6, the cross-sectional representation of the engagement in proximity to the nasal region between the chassis 102, the fabric trim frame 104, and fabric material 108 shows the interlocking mating between the components can also provide an anchoring mechanism for the fabric material. Further, as depicted in FIG. 6, anchoring the fabric material 108 in the interlocking mating 602 permits the fabric material 108 to be preloaded. In a further aspect, to preload the fabric, the fabric can be stretched before anchoring the fabric in the respective engagement points between the chassis 102 and fabric trim frame 104. To prevent the fabric material 108 from being overloaded and potentially degrading or tearing, the fabric can initially be stretched approximately 3 mm such that approximately 1N of force is placed on the fabric.

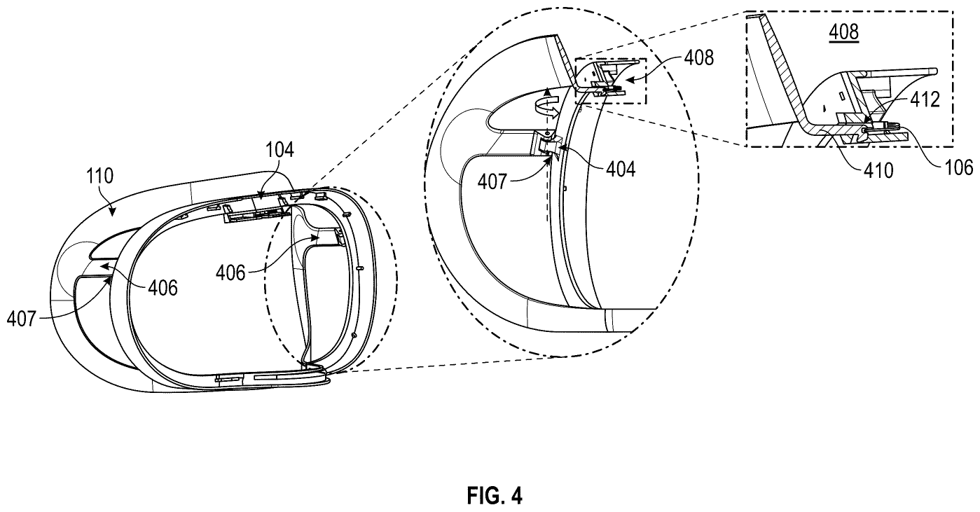

As shown in FIG. 4, an engagement between the fabric trim frame 104 and the facial ribbon 110 can comprise a plurality of additional trim connectors 406. One of the trim connectors 406 can comprise a pivoting coupling between the connection between the fabric trim frame 104 and the facial ribbon 110. In one aspect, the pivoting coupling 404 comprises a hinge-type pivoting rotation. In one aspect, the hinge-type pivot can be vertically aligned to compensate for a moment-force generated when a user rotates their head from side to side. Further, the hinge structure can include an over-rotation flange/stopper 407 to prevent the hinge-type pivoting rotation from over-rotating. In one aspect, the flange/stopper 407 can limit the rotation the pivoting coupling between approximately 0 to 90 degrees, wherein a rotation over 90 degrees can comprise a over-rotation. An over-rotation of the HMD at the pivoting couple causes facial ribbon/facial pad to disengage from the user's face when a user turns their head quickly. The pivoting coupling 404 between the fabric trim frame 104 and the facial ribbon 110 allows for additional user comfort. In particular, abrupt head movements can cause a force-moment by the weight of the HMD rotating about the wearer's face; the pivoting coupling 404 allows the face pad 112 to remain in contact with the user's face. In addition to the pivoting coupling 404, a supplemental engagement 408 can comprise a connecting protrusion 410 at the top region of the facial ribbon that can couple to a receiving crevice 412 by a top anterior region of the fabric trim frame 104. At the supplemental engagement 408, the torsion spring 106 can also engage with a linearly translating connecting protrusion 410 to maintain tension on the fabric material 108. The facial ribbon 110 can comprise a semi-rigid material such as a plastic-type material or carbon composite material that permits flexibility. The universal wearability of the assembly 100 for a plurality of users is enhanced by the combination of translational motion by the connecting protrusion 410 and the flexibility of the facial ribbon 110.

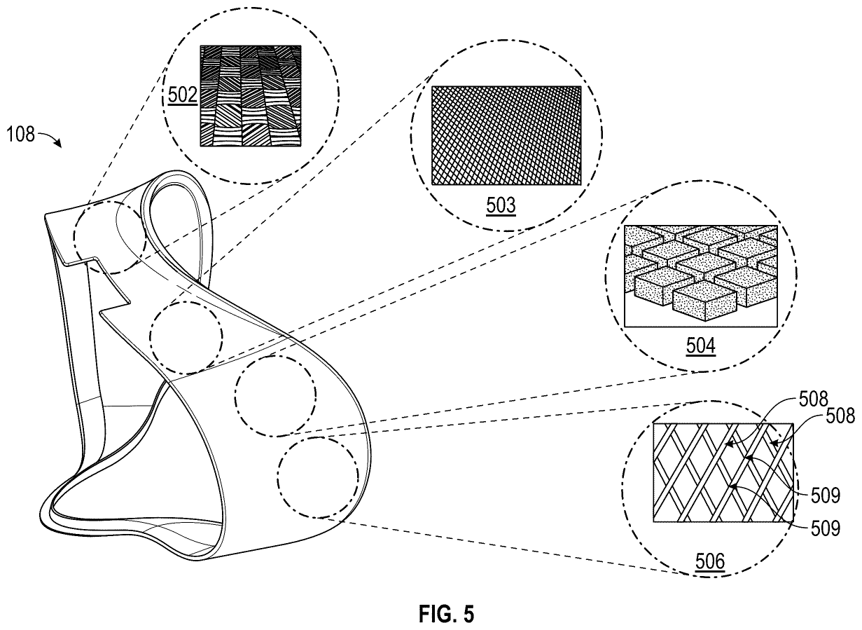

Occlusion wrap 108 can be configured to occlude light between the engagement of the facial ribbon 110 being coupled to the fabric trim frame 104. In a further aspect, the occlusion wrap/fabric material 108 can be breathable. The breathable fabric material can comprise a porosity that permits heat transfer from the area encapsulated by the occlusion wrap. In addition to heat transfer, the porosity of the breathable fabric material should allow airflow through the area encompassed by the occlusion wrap. In a further aspect, the porosity of the breathable fabric material is sufficient to permit passive airflow as a medium to cool the cavity surrounded by the occlusion wrap. In a further aspect, the occlusion wrap/fabric material can comprise a weaved pattern; the weaved pattern of the fabric material can be configured to mitigate light external to the fabric from interfering with the view path of the user when engaged with the HMD. Light mitigation properties of the occlusion materials can include polarization properties. For example, the weave of the fabric can be oriented to alter light propagation properties. Occlusion materials other than fabrics can comprise similar breathability and light polarization and light filtering characteristics. In a further aspect, as shown in FIG. 5, the occlusion materials for the occlusion wrap can comprise a variable surface texture 502. The variable surface texture and/or fabric weave can be configured to occlude light from the user's eyes by absorbing light. In a further aspect, the fabric material can be a dark color (e.g., dark grey or black) in order to absorb any reflected light on the interior surface of the fabric material. In an alternative embodiment, the fabric material can be a mesh 503 fabric.

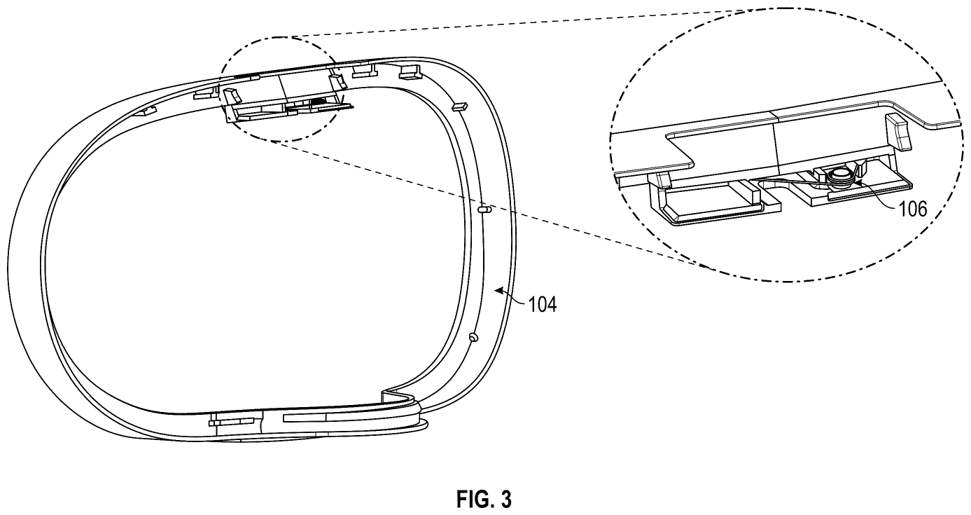

As depicted in FIG. 3, the engagement between the facial ribbon and trim frame can include a spring 106. In one aspect, the spring 106 can be a torsion spring. The torsion spring can be used to maintain the tension in the preloaded fabric material 108. Due to the flexibility of the facial ribbon 110, variances in the shape of the user's face and head can cause a different contour profile 114 for the facial ribbon 110; the contour profile 114 comprises the curvature of the facial ribbon 110 and face pad 112. The fabric material can be preloaded to minimize or eliminate wrinkling across compression of fabric. In one aspect, a change in the contour profile 114 can decrease the tension of fabric material 108 (e.g., cause the fabric material to sag). To maintain the fabric tension, translating motion of the connecting protrusion 410 engages the spring 106, causing the angle of the torsion spring to change; the change in the torsion spring angle causes a pull on the fabric material 108, maintaining the tension of the fabric material 108.

In the alternative, the occlusion wrap material can be sublimated wherein polyester and/or polymer-coated surfaces can be used to further scatter and absorb light 504. In another alternative aspect, the occlusion wrap 108 can comprise a material other than a fabric. The alternative material can still serve the primary function of obscuring light external to the HMD and light emanating from the HMD that may be reflected in the ocular region of the user. For example, smart light occluding materials can be used such as electrochromic films or photochromic files. The smart light occluding materials can change transparency or opacity based on a certain voltage or UV exposure. Other materials can also be used including: occlusive materials such as mylar. In yet another alternative aspect, the occlusion wrap 108 can comprise a breathable light-occluding construct 506. The occlusion construct 506 can include an expandable and contractable matrix of interconnected matrix members 508. The matrix members can comprise plastic-type materials, polymer or carbon composite materials that permit flexibility. The interconnection of members at pivot points 509 permit the expansion and contraction of the surface area defined by the matrix members 508. The matrix members 508 can be interconnected such that variances in the shape of a user's face can change the overall surface area of the occlusion construct 506. The combination of inherent material properties of the members 508, directional orientation of the members, and pivoted-coupling between the members can permit the occlusion construct to have a degree to freedom similar to an occlusion wrap comprising a fabric material. Further, an occlusion construct 506 with matrix members may permit additional hygienic capabilities. The construct 506 may be less likely to get dirty and may be easier to clean and/or sanitize in comparison to a fabric material. In addition, the spacing between the matrix members can still maintain the breathable functionality and heat dissipation functionality of the occlusion wrap made of a fabric material.

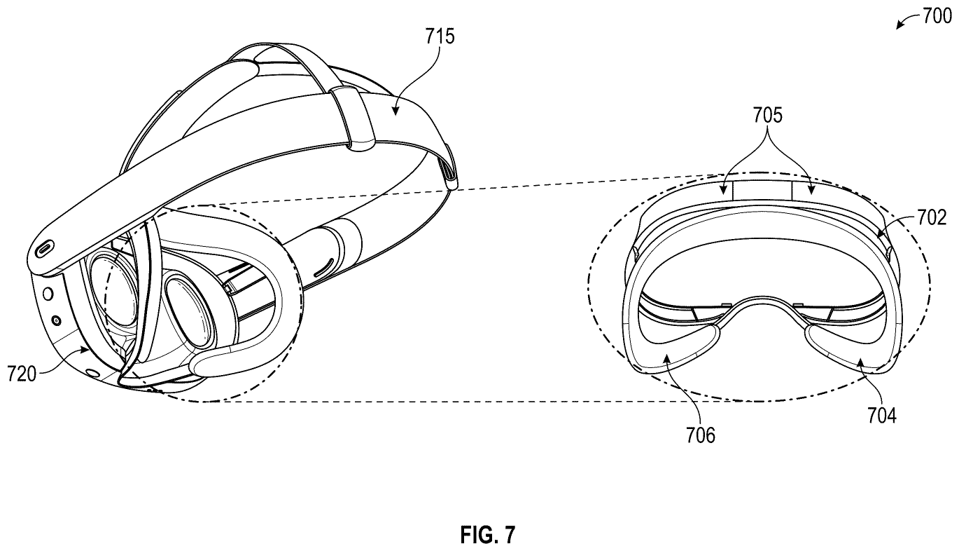

In an alternate embodiment as depicted in FIG. 7, the alternative facial assembly 700 can be structured to include a chassis 702 and facial ribbon 704. In contrast to another embodiment, as depicted in FIG. 1, the alternative facial assembly 700 provides a modular configuration excluding a fabric trim frame. The chassis 702 can comprise a semi-rigid material such as a plastic-type material or carbon composite material that permits flexibility, similar to the embodiment in FIG. 1. In the embodiment, a chassis 702 can couple to the HMD 720. In a further aspect, the chassis 702 can comprise lobe protrusions 705 that protrude from the frontal lobe area (top region of the chassis 702). The lobe protrusions can comprise a sufficient thickness that permits the lobe to provide an additional light occluding structure when facial assembly 700 is engaged to the HMD 720. The facial ribbon 704 can also be coupled to an aft surface of the chassis 702. The chassis 702 and the mated ribbon 704 can be coupled in proximity to a top region of the frontal lobe and at a lower region in proximity to the nasal bridge. In a further aspect, the ribbon 704 can comprise a face pad 706. The face pad 706 can comprise breathable fabric such as mesh and in another aspect the face pad 706 can comprise moisture wicking properties.

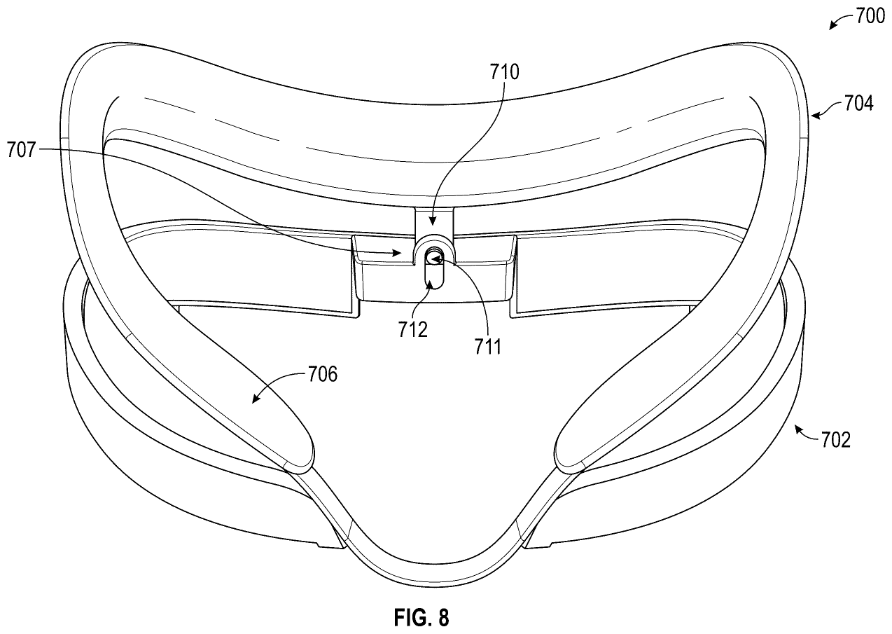

The engagement coupling 707, as depicted in FIG. 8, is similar to the supplemental coupling 408 wherein the connecting protrusion 710 is allowed to translate forward and aft with respect to the user's face. In an aspect, the connecting protrusion can comprise a knob 711 at the distal end of the connecting protrusion 710. The knob 711 can be oriented to translate in a channel 712 defined by an upper aft region of the chassis 702. The dimensions of the channel 712 define the limitation of translational motion from the connecting protrusion 710. The universal wearability of the assembly 700 for a plurality of users is enhanced by the combination of translational motion by the connecting protrusion 710 and the flexibility of the ribbon 704.

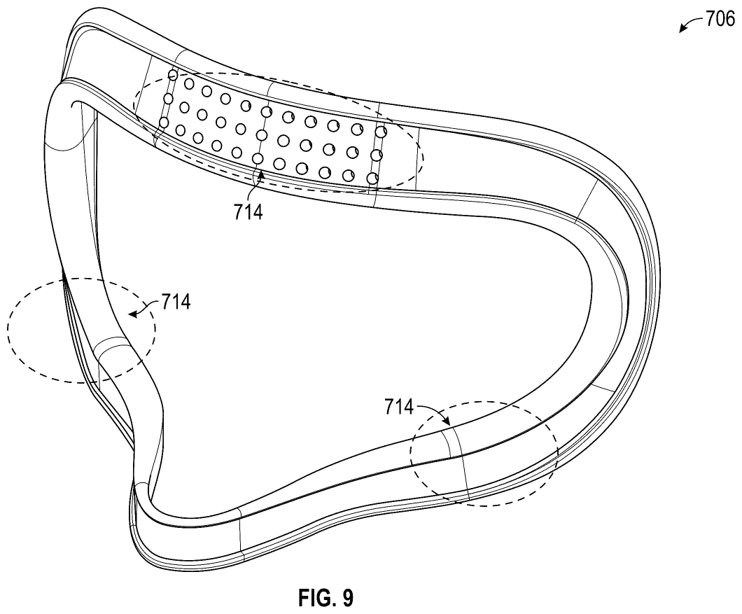

The face pad 706, as depicted in FIG. 9, can comprise an elastic material that deforms upon compression and reforms to an undeformed state when the force is removed (e.g., foam). In one aspect, the foam can be approximately 2.6 mm thick foam and approximately 1 mm thick silicone. The face pad, as depicted in FIG. 9, can be used in the facial assemblies in FIG. 1, FIG. 7, and FIG. 8. The face pad 706 can be interchangeable, wherein the face pad 706 can comprise different thicknesses to suit the comfort of different users. In particular, a head strap 715 is coupled to the HMD 720, with the head strap stabilizing the HMD 720 to the user's head. Movement by the user's head can cause a force-moment wherein the HMD places a distributed force on the user's face. The distributed force generates pressure points on protruding regions of the user's face (e.g., forehead and cheek bone area). The composition of the face pad 706 can further comprise a heterogenous composition wherein different regions of the face pad 706 can comprise regions of foam with different densities/elasticity. The foam regions of variable foam density/elasticity 714 can be used to compensate for pressure points on the protruding face regions (e.g., the forehead and cheek bone area).

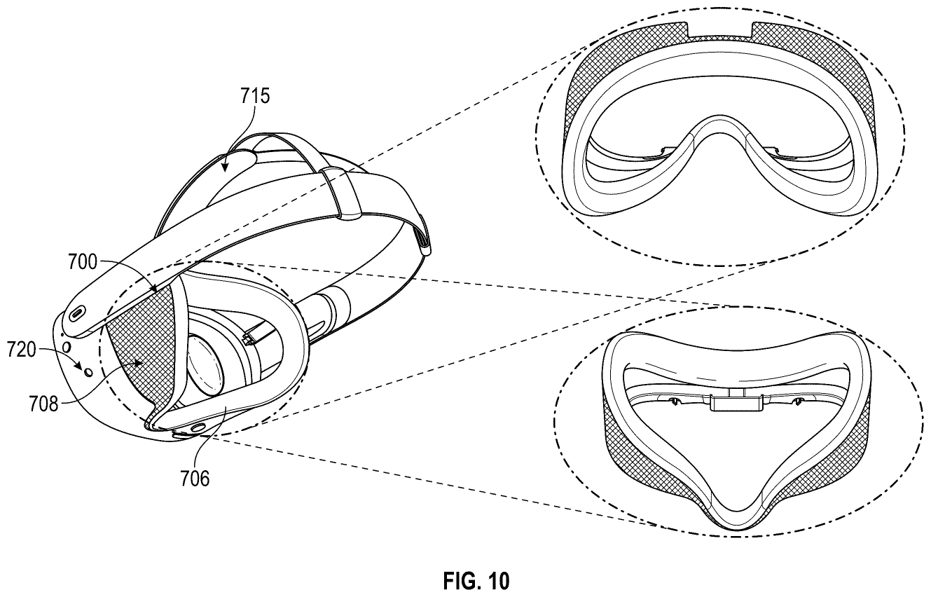

To compensate for the higher facial pressure points, a denser foam can be used to maintain user comfort. In a further aspect, as depicted in FIG. 10, in the alternative facial assembly 700, an occlusion wrap 708 can span a spatial gap oriented between the chassis 702 and ribbon 704. The occlusion wrap 708 in the alternative embodiment can comprise similar features as previously discussed wherein the occlusion wrap can comprise light occlusion properties as well as the wrap material can be breathable to enhance heat dissipation. Similarly, the occlusion wrap 708 can comprise the interconnected matrix members.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects. Other variations are within the scope of the following claims.

What is claimed is:

1. An apparatus configured to engage a mixed reality head mounted device (HMD), the apparatus comprising:
a chassis configured to engage a surface on an HMD;
a fabric trim frame coupled to the chassis;
a facial ribbon coupled to the fabric trim frame, wherein a coupling configured to engage the fabric trim frame and the facial ribbon comprises at least one pivoting hinge-type structure; and
an occlusion wrap oriented to engage between the fabric trim frame and the facial ribbon.

2. The apparatus of claim 1, wherein the facial ribbon comprises a ribbon protrusion oriented at a top surface of the fabric trim frame, the protrusion being oriented to linearly translate into a top region engagement with the fabric trim frame.

3. The apparatus of claim 2, further comprising a spring oriented in a top surface, the spring being structured to receive a force from the ribbon protrusion extending from the facial ribbon while the facial ribbon is coupled to the fabric trim frame.

4. The apparatus of claim 3, wherein the spring is a torsion spring.

5. The apparatus of claim 1, further comprising a face pad wherein the face pad is configured to mate with a contour profile of the facial ribbon determined by the shape of the facial ribbon.

6. The apparatus of claim 5, wherein the face pad comprises a plurality of elastic materials, such that the plurality of elastic materials is distributed in the face pad to compensate for a plurality of pressure points applied to the face pad, such that the pressure points are generated by a user's face.

7. The apparatus of claim 5, wherein a contour shape of the facial ribbon is shaped to mirror a face.

8. The apparatus of claim 1, wherein the at least one pivoting hinge-type structure comprises a vertical alignment and the at least one pivoting hinge-type structure is located on a side surface of the facial ribbon.

9. The apparatus of claim 1, wherein the pivoting hinge-type structure comprises an over rotation flange.

10. The apparatus of claim 1, further comprising an occlusion wrap comprising a fabric material, wherein the fabric material is preloaded.

11. The apparatus of claim 10, wherein the fabric material is preloaded at a plurality of engagement points located at an initial coupling with the fabric trim frame and a supplemental coupling with the facial ribbon.

12. The apparatus of claim 10, wherein the occlusion wrap comprises a textured surface, wherein a component of the texture extends above the textured surface.

13. The apparatus of claim 1, wherein at least one of: the chassis, the fabric trim frame, and the facial ribbon comprises an oil-resistant additive to prevent decomposition.

14. An apparatus configured to engage a mixed reality head mounted device (HMD), the apparatus comprising:
a chassis frame configured to engage a rear surface of the HMD; and
a facial ribbon comprising a contour profile, wherein the facial ribbon is coupled to a rear surface of the chassis frame, wherein the facial ribbon comprises at least one pivoting hinge-type structure.

15. The apparatus of claim 14, further comprising a face pad wherein the face pad is breathable and configured to mate with a contour profile of the facial ribbon determined by the shape of the facial ribbon.

16. The apparatus of claim 15, wherein the face pad comprises a plurality of elastic materials, such that the plurality of elastic materials is distributed in the face pad to compensate for a plurality of pressure points applied to the face pad, such that the pressure points are generated by a user's face.

17. The apparatus of claim 14, wherein the facial ribbon comprises a ribbon protrusion configured to translate linearly towards an engagement with the chassis frame, such that the ribbon protrusion translates in a channel defined by a top region of the chassis frame.

18. The apparatus of claim 14, wherein the at least one pivoting hinge-type structure comprises a vertical alignment and the at least one pivoting hinge-type structure is located on a side surface of the facial ribbon.

19. The apparatus of claim 14, wherein the chassis frame comprises lobe protrusions configured to extend forward from a top region of the chassis frame.

20. The apparatus of claim 14, further comprising an occlusion wrap comprising at least one of:
a breathable material;
a fabric material such that the fabric material is preloaded to maintain a tensile force in the fabric;
a textured surface, wherein a component of the texture extends above the textured surface; and
a matrix of interconnected members, wherein the interconnected members are structurally oriented to adjust a surface area of the occlusion wrap.
